(19) United States
(12) Patent Application Publication
(10) Pub. No.: US 2016/0182174 A1
(43) Pub. Date: Jun. 23, 2016

(54) GEOLOCATION INFORMATION FOR DVB-T2 STYLE SYSTEM

(71) Applicants: John Sidney STEWART, Indianapolis, IN (US); THOMSON LICENSING, Issy les Moulineaux (FR)

(72) Inventor: John Sidney STEWART, Indianapolis, IN (US)

(21) Appl. No.: 14/910,111

(22) PCT Filed: Dec. 18, 2013
(86) PCT No.: PCT/US2013/075954

§ 371 Date: Feb. 4, 2016

Related U.S. Application Data
(60) Provisional application No. 61/869,148, filed on Aug. 23, 2013.
(60) Provisional application No. 61/869,143, filed on Aug. 23, 2013.
(60) Provisional application No. 61/882,827, filed on Sep. 26, 2013.
(60) Provisional application No. 61/891,563, filed on Oct. 16, 2013.

(51) Int. Cl. H04H 60/51; H04H 20/72; H04N 5/44

(52) U.S. Cl. CPC H04H 60/51; H04N 5/4401; H04H 20/72

(57) ABSTRACT

A time reference field is added to an L1 pre-signaling table of a broadcast DVB-T2 signal and location information is added to a Cell List Descriptor of a Network Information Table (NIT) of the broadcast DVB-T2 signal. A DVB-T2 receiver uses the time reference field and the location information from 5 the received broadcast DVB-T2 signal to determine its location.

### CROSS-REFERENCE TO RELATED APPLICATIONS

This application claims the benefit of U.S. Provisional Application Nos. 61/869,148, filed Aug. 23, 2013 (docket number PU130123); 61/869,143, filed Aug. 23, 2013 (docket number PU130128); 61/882,827, filed Sep. 26, 2013 (docket number PU130158); and 61/891,563, filed Oct. 16, 2013 (docket number PU130168).

### BACKGROUND OF THE INVENTION

The present invention generally relates to communications systems and, more particularly, to a television (TV) system.

A geolocation feature can be useful under several scenarios including targeted advertising, estimation of reception conditions at specific locations, and mobile navigation. Unfortunately, in current broadcast TV it is not possible for a TV receiver (whether fixed or mobile) to determine its location from the received broadcast TV signals. One example of such a system is a Digital Video Broadcast Terrestrial (DVB-T) style system such as DVB-T2. In a current DVB-T2 system, the DVB-T2 receiver cannot determine its location from the received DVB-T2 signal. This is also unfortunate because the use of the VHF (very high frequency)/UHF (ultra high frequency) spectrum is of additional benefit as it can be easily received indoors. However, even with using the VHF/UHF spectrum there are still some limits to the accuracy of any geolocation system. In particular, the multipath characteristics of the transmission channel can cause errors in location estimation. For example, when a received signal is not a direct line of sight signal, but a reflected signal that has taken a longer path to the receiver, errors in location estimation may occur.

### SUMMARY OF THE INVENTION

In accordance with the principles of the invention, a time reference field is added to a broadcast TV signal for use by a receiver for implementing a geolocation feature to determine its location from the received broadcast TV signal.

In an illustrative embodiment of the invention, the broadcast TV signal is a DVB-T2 based system. A time reference field is added to an L1 pre-signaling table of a broadcast DVB-T2 signal and location information is added to a Cell List Descriptor of a Network Information Table (NIT) of the broadcast DVB-T2 signal. A DVB-T2 receiver uses the time reference field and the location information from the received broadcast DVB-T2 signal to determine its location.

In another illustrative embodiment, a broadcast TV receiver performs the following method: storing location information for a plurality of broadcast transmitters; receiving a time reference field value in a received broadcast signal from each of the plurality of broadcast transmitters; determining a time differential for each received broadcast signal by comparing the received time reference field value to a time of receipt at the broadcast TV receiver; and calculating a location for the broadcast TV receiver as a function of the plurality of time differentials and stored location information for the plurality of broadcast transmitters.

In view of the above, and as will be apparent from reading the detailed description, other embodiments and features are also possible and fall within the principles of the invention.

### BRIEF DESCRIPTION OF THE DRAWINGS

FIG. 1 shows an illustrative DVB-T2 compatible signal format in accordance with the principles of the invention;

FIG. 2 shows an illustrative DVB-T2 L1 pre-signaling table in accordance with the principles of the invention;

FIG. 3 shows an illustrative Cell List Descriptor for use in DVB-T2 in accordance with the principles of the invention;

FIG. 4 shows an illustrative DVB-T2 transmitter in accordance with the principles of the invention;

FIG. 5 shows another illustrative embodiment in accordance with the principles of the invention;

FIG. 6 shows an illustrative flow chart for use in a receiver in accordance with the principles of the invention; and

FIG. 7 shows an illustrative embodiment of a receiver in accordance with the principles of the invention.

### DETAILED DESCRIPTION

Other than the inventive concept, the elements shown in the figures are well known and will not be described in detail. For example, other than the inventive concept, a set-top box or digital television (DTV) and the components thereof, such as a front-end, Hilbert filter, carrier tracking loop, video processor, remote control, etc., are well known and not described in detail herein. In addition, other than the inventive concept, familiarity with networking and current and proposed recommendations for TV standards is assumed and not described herein. Such as, e.g., NTSC (National Television Systems Committee); PAL (Phase Alternation Lines); SECAM (SEquential Couleur Avec Memoire); ATSC (Advanced Television Systems Committee) (e.g., ATSC Standard: Program and System Information Protocol for Terrestrial Broadcast and Cable (PSIP) Document A/65); Chinese Digital Television System (GB) 20600-2006; Digital Video Broadcasting (DVB-T2) and DVB-H. In particular, familiarity with the following DVB-T2 standards is assumed: ETSI EN 302 755 V1.3.1: Digital Video Broadcasting (DVB); Frame structure channel coding and modulation for a second generation digital terrestrial television broadcasting system (DVB-T2); ETSI TS 102 992: Digital Video Broadcasting (DVB); Structure and modulation of optional transmitter signatures (T2-TX-SIG) for use with the DVB-T2 second generation digital terrestrial television broadcasting system; and ETSI EN 300 468: Digital Video Broadcasting (DVB); Specification for Service Information (SI) in DVB systems. It should also be noted that the inventive concept may be implemented using conventional programming techniques, which, as such, will not be described herein. Finally, like-numbers on the figures represent similar elements.

As described earlier, it is desirable to determine a physical position for a receiver using over-the-air transmissions. In this regard, a DVB-T2 receiver could determine its location from received transmissions if the receiver knows the physical location of the transmitters and a reference time for each of the transmitters. However, in current DVB-T2 based systems, there is not enough information for a receiver to determine the location of the receiver from the received signals.

In accordance with the principles of the invention, a time reference field is added to a broadcast TV signal for use by a receiver for implementing a geolocation feature to determine its location from the received broadcast TV signal. In an illustrative embodiment of the invention, a DVB-T2 compatible signal format is modified to include a time reference (an absolute time of transmission) and physical location information for a DVB-T2 transmitter for providing a geolocation feature in the receiver. In addition, the inventive concept also makes use of the Future Extension Frame (FEF) feature of DVB-T2. The FEF feature is defined in section 8.4 of ETSI EN 302 755 V.1.3.1 and is further defined in section 6 of ETSI TS 102 992. The FEF feature enables identification of the source transmitter. In addition, the defined waveforms in ETSI TS 102 992 are designed to determine the impulse response of individual SFN (single frequency network) transmitters, and also allows the determination of the relative timing between the received signals from multiple SFN transmitters.

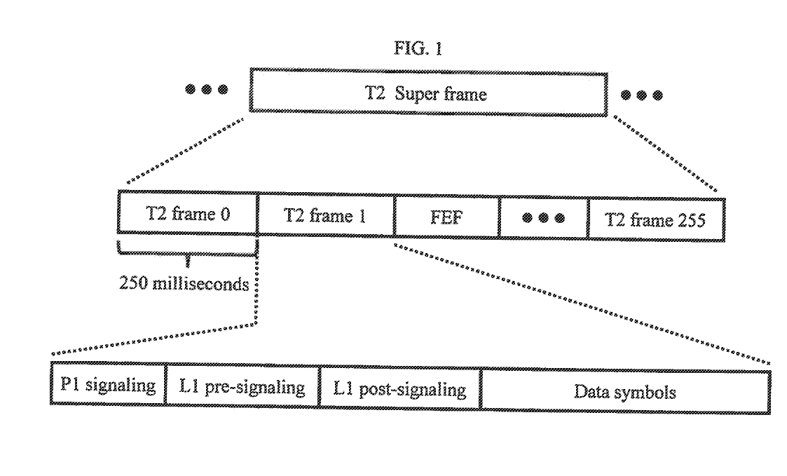

A DVB-T2 compatible signal format in accordance with the principles of the invention is illustrated in FIG. 1. As shown in FIG. 1, a DVB-T2 compatible signal format is comprised of a sequence of super frames (as represented by the ellipses), each super frame comprising, at most, 256 T2 frames (numbered from 0 to 255). Each T2 frame is, at most, 250 milliseconds long. In addition, each superframe may also comprise one, or more, Future Extension Frames (FEFs). Each T2 frame carries P1 signaling, L1 pre-signaling, L1 post signaling and data symbols for the physical layer pipes (PLPs) (e.g., see ETSI EN 302 755 and ETSI TS 102 831). The PLPs carry the services, e.g., programs for viewing by a user. As illustrated in FIG. 1, the L1 pre-signaling data is transmitted as a part of the preamble in the initial part of a T2 frame.

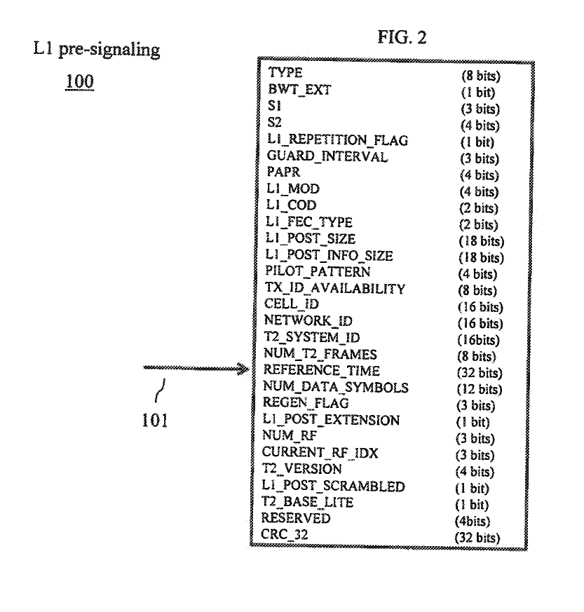

In accordance with the principles of the invention, the L1 pre-signaling data of FIG. 1 is modified to include a reference time. There are many methods to insert a reference time, the suggested method is to add a 32 bit rolling counter that is referenced to time 0 of the GPS (global positioning system) time in the L1 pre-signaling table. As shown in FIG. 2, the L1 pre-signaling table 100 of DVB-T2 is modified to now include a REFERENCE_TIME field with a length of 32 bits as indicated by arrow 101. This 32-bit field represents a value of a reference counter that runs at 10 MHz and has a value from 0-599999999, i.e., it is reset every minute. (A 10 MHz clock is available from most GPS time reference systems.) This reference time indicates the time at which the start of the FEF frame is leaving the transmit tower, i.e., an absolute time of transmission. This data can be generated by knowing the current GPS reference time (or UTC time) at the transmitter and the delay from the data insertion time to when the FEF frame leaves the transmit tower (i.e., account for the delay in any buffering and transit time to the top of the transmit tower). When the receiver receives the FEF frame, it can check its own clock and determine a time differential to be used in calculating its location. This absolute time of transmission does not need to be a full UTC time (coordinated universal time), only a reference time that is the same for all transmitters. This modified L1 pre-signaling table is sent in the T2 frame immediately prior to the FEF frame as illustrated in FIG. 1.

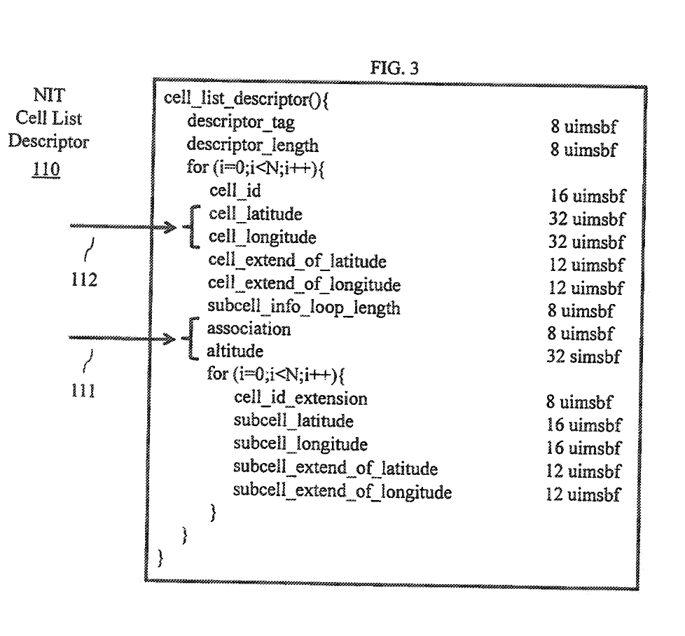

The last pieces of information that are needed for geolocation calculation are the locations of the transmitters and the association of the signature waveforms described in ETSI TS 102 992 with each transmitter. This should be done in the higher layers of the protocols. An example of how this can be accomplished would be to use the Network Information Table (NIT) of DVB-T2. For example, a Cell List Descriptor as described in section 6.2.6 of ETSI EN 300 468. A modified Cell List Descriptor 110 is illustrated in FIG. 3. Additional fields are added as shown by arrow 111 for an “association” and an “altitude”. The “association” field indicates the association between the transmitter described in the list and the signature waveform in the FEF frame. This requires at least a 6 bit field to describe which of the 64 signature waveforms is transmitted by this transmitter. The present disclosure is to use an 8 bit waveform to allow for future expansion of the number of signature waveforms. The “altitude” field is a 32 bit signed field giving the height from sea level in cm. The latitude and longitude fields would also need to be extended from the current 16 bits to 32 bits as illustrated by arrow 112. The values for the altitude, latitude and longitude fields are known a priori for each transmitter. These are also referred to as geocentric information. The value for the association field is known when the signature waveform in the FEF frame is selected by the transmitter. The NIT is a part of the layer 2 signaling in DVB-T2 and is transmitted in the data symbols portion of a T2 frame.

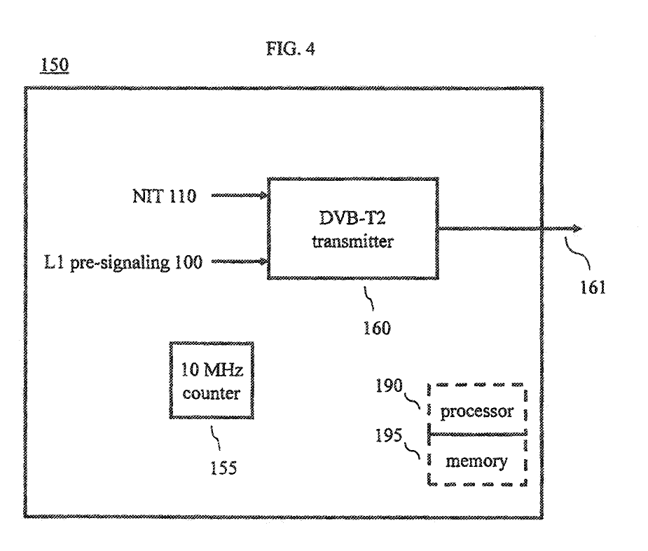

Referring now to FIG. 4, an illustrative embodiment of a DVB-T2 style transmitter 150 in accordance with the principles of the invention is shown. Only that portion of transmitter 150 relevant to the inventive concept is shown, e.g., the processing of L1 pre-signaling table 100 and the NIT 110 of FIGS. 2 and 3. Other than the inventive concept, transmitter 150 conforms to DVB-T2 standards, e.g., see the DVB-T2 implementation guidelines described in ETSI TS 102 831 and ETSI EN 302 755. Transmitter 150 is representative of any processor-based platform for transmission of a signal. In this regard, transmitter 150 includes one, or more, processors and associated memory as represented by processor 190 and memory 195 shown in the form of dashed boxes in FIG. 4. In this context, computer programs, or software, are stored in memory 195 for execution by processor 190. The latter is representative of one, or more, stored-program control processors and these do not have to be dedicated to the transmitter function, e.g., processor 190 may also control other functions of transmitter 150. Memory 195 is representative of any storage device, e.g., random-access memory (RAM), read-only memory (ROM), etc.; may be internal and/or external to transmitter 150; and is volatile and/or non-volatile as necessary. Transmitter 150 comprises 10 MHz counter 155 and DVB-T2 transmitter 170. The latter is representative of the coding, framing, modulation, etc., in DVB-T2. Any or all of these components may be implemented in software as represented by processor 190 and memory 195. The NIT 110 described above is modified to include the Cell List Descriptor in accordance with the principles of the invention as shown in FIG. 3. As noted earlier, the values for the altitude, latitude and longitude fields are known a priori for each transmitter. The value for the association field is known when the signature waveform in the FEF frame is selected by the transmitter. The NIT is a part of the layer 2 signaling in DVB-T2 and is transmitted in the data symbols portion of a T2 frame. L1 pre-signaling 110 is modified to include the reference time as shown in FIG. 2. As noted earlier, this reference time indicates the time at which the start of the FEF frame is leaving the transmit tower, i.e., an absolute time of transmission. This data can be generated by knowing the current GPS reference time (or UTC time) at the transmitter and the delay from the data insertion time to when the FEF frame leaves the transmit tower (i.e., account for the delay in any buffering and transit time to the top of the transmit tower). This absolute time of transmission does not need to be a full UTC time (coordinated universal time), only a reference time that is the same for all transmitters. This time is chosen as a counter running at 10 MHz that is reset each minute (as represented by 10 MHz counter 155 under the control of processor 190). The range of the counter is therefore 0-599999999. The L1 pre-signaling is sent in the T2 frame immediately prior to the FEF frame as illustrated in FIG. 1. Finally, DVB-T2 transmitter 160 uses the FEF feature (described above) and provides a signal 161 for transmission via an antenna (not shown).

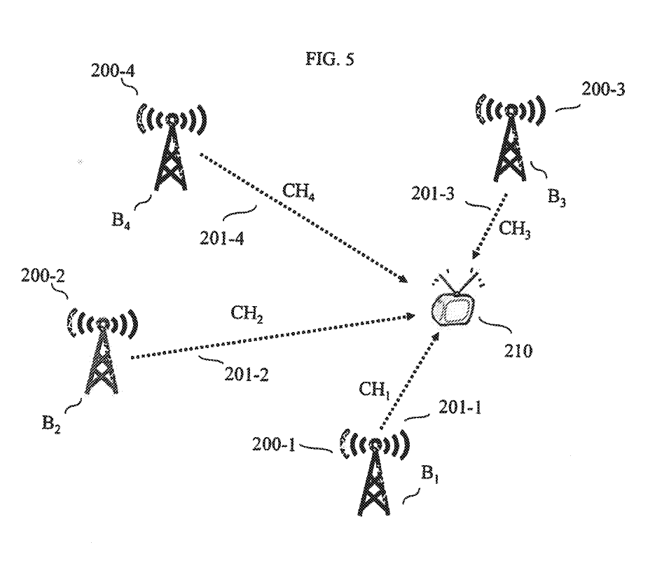

As known in the art, in order to estimate the receiver location in 3 dimensional space as well as the local time, at least 4 separate signals need to be received. If fewer than 4 signals are received, then the location determination has some ambiguity, and only a subset of the location and local time can be estimated. However, even with some ambiguity, there can be enough information to be useful for the broadcaster. For the purposes of this description, it is assumed that 4 separate signals are received as illustrated in FIG. 5.

As shown in FIG. 5, there are four DVB-T2 broadcasters: 200-1 (B₁), 200-2 (B₂), 200-3 (B₃) and 200-4 (B₄). In this example, broadcaster 200-1 transmits a signal 201-1 on channel 1 (CH₁), broadcaster 200-2 transmits a signal 201-2 on channel 2 (CH₂), broadcaster 200-3 transmits a signal 201-3 on channel 3 (CH₃) and a broadcaster 200-4 transmits a signal 201-4 on channel 4 (CH₄). In accordance with the principles of the invention, each broadcaster transmits a modified L1 pre-signaling table and Cell List Descriptor as described above and shown in FIGS. 2 and 3. In addition, each broadcaster implements the FEF feature as described above. In accordance with the principles of the invention, a DTV receiver 210 is tuned to each of these channels for the purpose of determining the location of DTV receiver 210. DTV receiver 210 is representative of a fixed, or mobile, device.

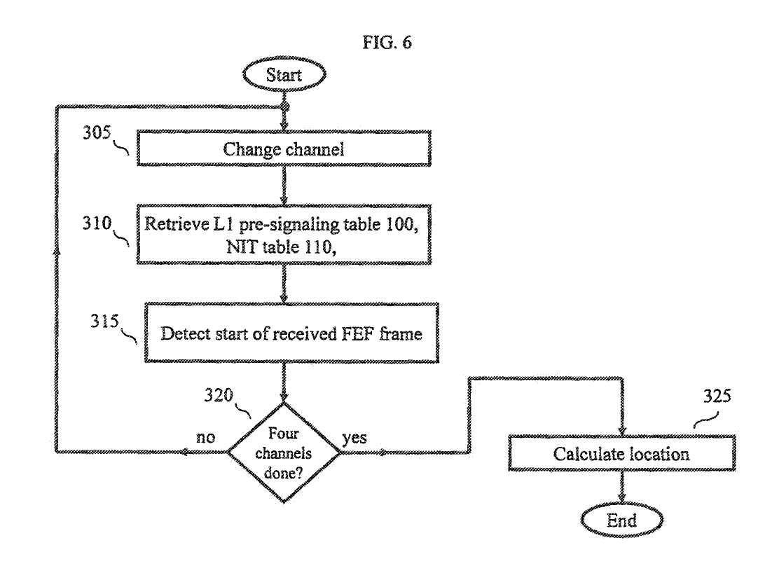

An illustrative method for use in DTV receiver 210 in accordance with the principles of the invention is shown in FIG. 6. In step 305, DTV receiver 210 changes channel, e.g., to CH₁ of FIG. 5. In step 310, DTV receiver 210 retrieves the reference time value from the received L1 pre-signaling table 100 for broadcaster 1 and also retrieves the Cell List Descriptor 110 conveyed in the received NIT for broadcaster 1. In step 315, DTV receiver 210 detects the start of the received FEF frame from broadcaster 1. In step 320, DTV receiver 210 determines if 4 channels have been received. If DTV receiver 210 has not checked four channels, DTV receiver 210 returns to step 305 and changes channels again to, e.g., perform steps 310 and 315 for each of the remaining channels: CH₂, CH₃ and CH₄ for each of those broadcasters. Once DTV receiver 210 has checked four channels, DTV receiver 210 calculates its location in step 325.

In terms of step 325, GPS calculations are known in the art and not described in detail herein. As noted above, it is preferable that the receiver receive at least four different signals. For each received signal, the receiver should have the geocentric coordinates of the corresponding transmitter. In the context of the invention, these are the altitude, latitude and longitude fields of Cell List Descriptor 110. In addition, the receiver needs the time of transmission, this is the reference time field in the L1 pre-signaling table 100. The receiver also measures the time of reception at the receiver. With four signals, the following equation is solved for the four unknowns x, y, z, b:

(xᵢ−x)²+(yᵢ−y)²+(zᵢ−z)²=(ρᵢ−b)² (1)

where x, y and z represents the geocentric coordinates of the receiver; and b is the size of the possible error. Each parameter xᵢ, yᵢ and zᵢ represents the geocentric coordinates for each corresponding transmitter. The parameter ρᵢ represents the distance between each transmitter and the receiver and is given by:

ρᵢ=c(Tᵢ−tᵢ) (2)

where c is the speed of light in meters per nanosecond, Tᵢ is the time the receiver receives the information from that transmitter, and t is the time of transmission of that information from that transmitter. It should be noted that (Tᵢ−tᵢ) is a time differential.

It should be noted that when DTV receiver 210 receives the reference time for transmission, DTV receiver 210 should correct for any internal buffering or processing delay that is present in the receiving algorithms. While the upper protocol layers send UTC time, it is more difficult to get an accurate representation of the receive time due to the amount and variability of time delay due to interleaving, processing delay, and buffering. At the physical layer, a hardware clock in DTV receiver 210 can be used to capture the FEF frame boundary time with a high accuracy.

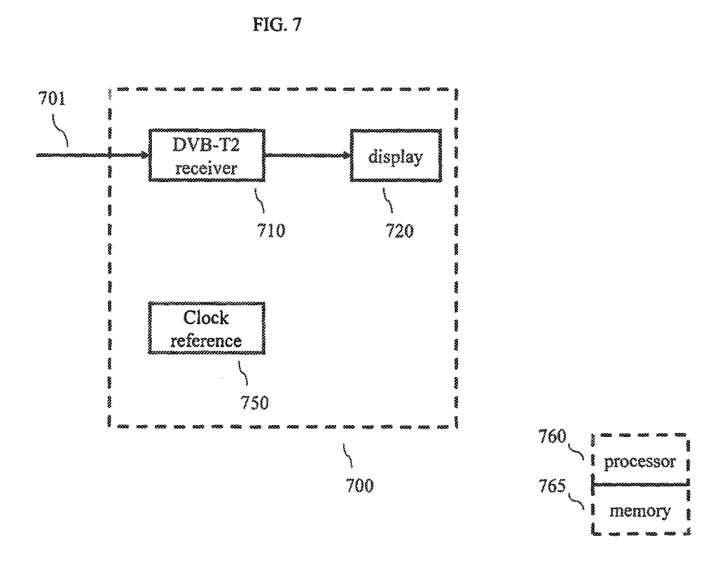

A high-level block diagram of an illustrative device in accordance with the principles of the invention is shown in FIG. 7. Device 700 (e.g., a television) includes a DVB-T2 receiver 710, a clock reference 750 and a display 720. DVB-T2 receiver 710 receives a broadcast DVB-T2 signal 701 (e.g., via an antenna not shown) for processing to recover therefrom, e.g., an HDTV (high definition TV) video signal for application to display 720 for viewing video content thereon. In addition, DVB-T2 receiver 710 retrieves the reference time and Cell List Descriptor in accordance with the principles of the invention for implementing a geolocation feature as represented by the flow chart of FIG. 6. Device 700 is a processor-based system and includes one, or more, processors and associated memory as represented by processor 760 and memory 765 shown in the form of dashed boxes in FIG. 7. In this context, computer programs, or software, (e.g., representing the flow chart of FIG. 6) are stored in memory 765 for execution by processor 760. As noted, processor 760 is representative of one, or more, stored-program control processors and these do not have to be dedicated to any one particular function of device 700, e.g., processor 760 may also control other functions of the device. Memory 765 is representative of any storage device, e.g., random-access memory (RAM), read-only memory (ROM), etc.; may be internal and/or external to the device; and is volatile and/or non-volatile as necessary.

As described above, and in accordance with the principles of the invention, a DVB-T2 receiver implements a geolocation feature. Although the inventive concept was described in the context of DVB-T2, similar modifications can be made to other broadcast TV systems, e.g., the addition of a reference time and location information for each transmitter. For example, similar modifications could be made to the Program and System Information Protocol (PSIP) of ATSC by adding a new table type that would give the locations of the transmitters and the signature waveform associations. The PSIP of ATSC is described in ATSC Document A/65. As such the inventive concept is not limited to DVB-T2. In addition, for non SFN networks, geolocation can still be used by tuning to different nonsynchronized transmitters. Since there is only one transmitted signal, the FEF cannot be used to determine the location of several transmitters at once. It can however be used to determine the time offset for a single transmitter. If multiple channels are tuned, then multiple time of arrival estimates can be found. This method will be less accurate as the clocks for the various transmitters are more likely to have some synchronization error. Also, the accuracy of the receiver internal clock may add some error as it will take some time to tune the various transmitters and capture a geolocation FEF. During this time, the receiver internal clock may drift, introducing some additional timing error.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. It is therefore to be understood that numerous modifications may be made to the illustrative embodiments and that other arrangements may be devised without departing from the spirit and scope of the present invention.

1. A method for use in a broadcast television (TV) receiver, the method comprising:
storing location information for a plurality of broadcast transmitters;
receiving a time reference field value in a received broadcast signal from each of the plurality of broadcast transmitters;
determining a time differential for each received broadcast signals by comparing the received time reference field value to a time of receipt at the broadcast TV receiver; and
calculating a location for the broadcast TV receiver as a function of the plurality of time differentials and stored location information for the plurality of broadcast transmitters.

2. The method of claim 1, wherein the received broadcast signal is a DVB-T2 type signal.

3. The method of claim 2, wherein the storing step further comprises:
retrieving geocentric information from the received broadcast signal for each of the plurality of transmitters; and
storing the retrieved geocentric information as the location information.

4. The method of claim 3, wherein the geocentric information is retrieved from a Cell List Descriptor of a Network Information Table from the received broadcast signal.

5. The method of claim 2, wherein the received time reference field value is conveyed in an L1 pre-signaling table of the received broadcast signal.

6. The method of claim 1, wherein the received broadcast signal is an ATSC type signal and the location information and received time reference field are conveyed in a table of the program and system information protocol (PSIP) of ATSC.

7. A broadcast television (TV) receiver, the broadcast TV receiver comprising:
a receiver for providing location information and a time reference field value from each one of a plurality of received broadcast signals for corresponding broadcast transmitters; and
a processor for calculating a location of the broadcast TV receiver using the location information and time reference field value for the corresponding broadcast transmitters.

8. The apparatus of claim 7, wherein the processor determines a time differential for each received broadcast signal by comparing the received time reference field value to a time of receipt at the broadcast TV receiver.

9. The apparatus of claim 7, wherein the received broadcast signal is a DVB-T2 type signal.

10. The apparatus of claim 9, wherein the location information is retrieved from a Cell List Descriptor of a Network Information Table from the received broadcast signal.

11. The apparatus of claim 9, wherein the time reference field value is conveyed in an L1 pre-signaling table of the received broadcast signal.

12. The apparatus of claim 7, wherein the received broadcast signal is an ATSC type signal and the location information and received time reference field are conveyed in a table of the program and system information protocol (PSIP) of ATSC.
